(19) United States
(12) Patent Application Publication
(10) Pub. No.: US 2002/0001728 A1
(43) Pub. Date: Jan. 3, 2002

(54) Method of layer-by-layer application of treatment chemicals to fiber-based planar products and products made using same

(76) Inventors: Walter F. Hill, Lampertheim/Hofheim (DE); Stephan Eichhorn, Gernsheim (DE)

Correspondence Address: BURNS DOANE SWECKER & MATHIS L L P, POST OFFICE BOX 1404, ALEXANDRIA, VA, 22313-1404, US

(21) Appl. No.: 09/749,815

(22) Filed: Dec. 28, 2000

(30) Foreign Application Priority Data
Dec. 30, 1999 (DE) DE - 199 63 828.4

(51) Int. Cl. B05D 1/36

(52) U.S. Cl. 428/452; 428/537.5; 427/411

(57) ABSTRACT

The present invention relates to a method of applying treatment chemicals to a dry, creped tissue material, said method comprising the steps of:

a) applying a first treatment composition containing at least one treatment chemical to the dry, creped tissue material to produce a first layer having at least one first treatment chemical, and

b) applying at least one further treatment composition containing at least one other treatment chemical to produce at least one other layer on the first layer, said other layer having at least one other treatment chemical,

and a tissue material or tissue product obtainable according to this method.

The process of the invention enables the production of tissue products, wherein the treatment chemicals are optimally distributed, depending on their purpose of use, and can develop their properties.

### SPECIFICATION

The present invention relates to a method of applying treatment chemicals to fiber-based planar products, particularly tissue. It also relates to a device for performing the method and to the products made using same.

Within the framework of the present invention, the term “tissue” especially includes “tissue paper” or “raw tissue”, as is normally produced as a one-ply tissue web in the tissue (paper) machine, as well as including multiply (intermediate) products, e.g. in the form of multiply doubled webs or in the form of master rolls for further processing and ready-made one-ply and multiply tissue products such as paper handkerchiefs, facials, toilet paper, household towels such as kitchen towels, hand towels and other wipes etc.

### PRIOR ART

Based on the underlying correspondence of the production processes (wet laying), “tissue” production is counted among the paper making techniques. The production of tissue, or more accurately, raw tissue if the one-ply (intermediate) product manufactured on a special-purpose paper machine of the tissue or tissue paper machine is meant, is delimited from paper production as a result of the extremely low basis weight of normally less than 40 g/m² and as a result of the much higher tensile energy absorption index as compared to paper. The tensile energy absorption index is arrived at by relating the tensile energy absorption to the test sample volume before inspection (length, width, thickness of sample between the clamps before tensile load).

Paper and tissue paper also differ in general with regard to the modulus of elasticity that characterizes the stress-strain properties of these planar products as a material parameter, depending on the production conditions, raw materials used and chemical additives.

A tissue paper's high tensile energy absorption index results from the outer and/or inner creping. The former is produced by compression of the tissue paper web adhering to a dry cylinder as a result of the action of a crepe doctor or in the latter instance as a result of a difference in speed between two successive screens or e.g. between a sheet-forming screen and a so-called fabric or between two fabrics.

When applying the through air drying (TAD) technique for the production of raw tissue and the usual double-screen sheet formation in c-wrap configuration, for example, the so-called inner sheet-forming screen can thus be operated at a speed that is up to 40% faster than that of the next fabric or that of the subsequent felt, the initially formed and already pre-drained paper web being transferred to the next TAD fabric. This causes the still moist and as a result plastically deformable paper web to be internally broken up by compression and shearing, thereby rendering it more stretchable under load than a paper that has undergone neither “internal” nor external creping.

This transfer of a still plastically deformable paper web at a differential speed that simultaneously takes effect may also be brought about in other embodiments between a transfer fabric and the so-called TAD imprinting fabric or between two transfer fabrics.

German has adopted the English-language term “fabric” to designate paper machine covers that exhibit a screen-like fabric structure in which synthetic threads are used as a thread material instead of metal wires.

Most of the functional properties typical of tissue and tissue products result from the high tensile energy absorption index (see German standards DIN EN 12625-4 and DIN EN 12625-5). An example is represented by tissue products for hygienic applications (hygiene products, particularly hygiene paper products) which are e.g. used in personal grooming and hygiene, the household sector, industry, the institutional field in a very wide variety of cleaning processes. They are used to absorb fluids, for decorative purposes, for packaging or even just as supporting material, as is common for example in medical practices or in hospitals. In terms of their-wide variety, hygiene products are now considered to be everyday products.

Hygiene paper primarily includes all kinds of dry-creped tissue paper, as well as wet-creped paper.

The one-ply intermediate products originating from the paper machine and made of lightweight, i.e. low basis weight paper usually dry-creped on a yankee cylinder by means of a crepe doctor are generally described as “tissue paper” or more accurately raw tissue paper. The one-ply raw tissue may be built up of one or a plurality of layers respectively.

All one-ply or multiply final products made of raw tissue and tailored to the end user's needs, i.e. fabricated with a wide variety of requirements in mind, are known as “tissue products”.

Typical properties of tissue paper include the ready ability to absorb tensile stress energy, their drapability, good textile-like flexibility, properties which are frequently referred to as bulk (crumple) softness, a high surface softness, a high specific volume with a perceptible thickness, as high a liquid absorbency as possible and, depending on the application, a suitable wet and dry strength as well as an interesting visual appearance of the outer product surface. These properties allow tissue paper to be processed into tissue products (tissue paper products) and are then available to end users in a wide variety of forms and fabrication, for example as wipes, towels, household towels, particularly as kitchen towels, sanitary products (e.g. toilet paper), paper handkerchiefs, cosmetic tissues (facials) or serviettes/napkins.

Depending on the particular application, varied and to an extent conflicting properties are frequently needed for the successful use of tissue products in their extremely broad range of applications.

For this purpose, the tissue is frequently provided with substances, additives, auxiliary substances and other treatment chemicals.

In accordance with the invention, this term will also cover any substance or blends of substances generally referred to as treatment chemicals and normally applied to the tissue after the drying and creping step on the yankee cylinder.

Treatment chemicals may have an influence on physical properties, e.g. softness, particularly bulk softness, strength in the dry and wet states, rate of absorption of liquids, particularly that of water or oil, or the structural strength of the tissue/tissue product itself, and/or they may contribute to their varying use, e.g. in the field of skin care and protection, healthcare, etc. “Lotions” are also particularly referred to in the latter case.

Household towels for example, particularly kitchen towels and to an even greater extent paper towels, require strength, especially in the wet state, and high suction capacity so as to satisfy consumer demands. In the case of toilet paper, a combination of dry strength plus good softness is more likely to determine suitability in practice and acceptance among consumers. In the case of other tissue products such as handkerchiefs or facial wipes, surface softness and excellent suppleness are predominant properties which, in addition to strength, define the serviceability of these products.

Cosmetic components contained in the product, particularly on its outer surfaces, also play an important part in the latter tissue products. Such cosmetic components include, inter alia, perfumes, moisturizers, skin care agents, healthcare substances such as D-panthenol or the active camomile ingredient α-bisabolol.

It is important in the case of cosmetic components to achieve an optimum transfer of the components such as care agents or moisturizers from the tissue product to the skin—optimum in the sense of an adequate quantity of such components—so as to promote the desired effect. High amounts of the cosmetic substances to be applied to the tissue are necessary for this purpose. On the other hand, the tissue itself must not feel unpleasant or e.g. leave behind a wet feeling on the skin.

Manufacturers of tissue products are therefore especially faced with the challenge of achieving a particular balance between the various, frequently contradictory parameters in order to use this balance to obtain the optimum combinations of features required by consumers for the desired final products. The article entitled “Weichheit und Weichmachung von Hygiene-Tissue” in the Wochenblatt fur Papierfabrikation, No. 11/12, 1988, pages 435 et seq., describes in detail the properties of hygiene tissue and discusses their importance to tissue products in different applications.

Thus, one of the principal market demands to be met by manufacturers is a general improvement in softness across all areas of tissue products. Properties such as the softness of a tissue product are defined in terms of their basic design by the production process, particularly by preliminary TAD and the choice of raw and auxiliary materials.

Softness is an important property of tissue products such as handkerchiefs, cosmetic wipes, toilet paper, serviettes/napkins, not to mention hand or kitchen towels, and it describes a characteristic tactile sensation caused by the tissue product upon contact with the skin.

Although the term “softness” is generally comprehensible, it is extremely difficult to define because there is no physical method of determination and consequently no recognized industrial standard for the classification of different degrees of softness.

To be able to detect softness at least semi-quantitatively, softness is determined in practice by means of a subjective method. To do so, use is made of a “panel test” in which several trained test persons give a comparative opinion.

In simplified terms, softness can be subdivided into its main characteristics, surface softness and bulk softness.

Surface softness describes the feeling perceived when e.g. one's fingertips move lightly over the surface of the sheet of tissue. Bulk softness is defined as the sensory impression of the resistance to mechanical deformation that is produced by a tissue or tissue product manually deformed by crumpling or folding and/or by compression during the process of deformation.

The application of the aforementioned treatment chemicals with which e.g. the desired softness characteristics or other properties are to be achieved is brought about in the prior art by different roll and spray application techniques. Other methods include impregnation techniques.

WO 94/05857 describes a method of applying a chemical paper-making additive to a dry tissue paper mat (tissue paper nonwoven fabric, raw tissue). The application technique is characterized by the following steps: provision of a dry tissue paper mat, dilution of a chemical paper-making additive using a suitable solvent to form a diluted chemical solution, the application of this diluted chemical solution to a heated transfer surface, partial evaporation of the solvent through the transfer surface to form a film that contains this paper-making additive and the transfer of this film from the heated transfer surface to the surface of the tissue mat.

EP-A-03 47 177 relates to a method of making soft tissue paper comprising the following steps: forming sheets from an aqueous suspension of cellulose fibers to form a mat, application of a sufficient amount of water-soluble non-cationic surfactant and drying and creping the mat, this tissue paper exhibiting a basis weight of 10 to 65 g/m² and a density of less than 0.6 g/m³.

The treatment solution can therefore be added both in the wet section of a tissue paper machine (wadding machine), at the end of the screen section, before or inside the press section (mechanical drainage), i.e. in the case of solid contents between 20 and 50%, and in the dry section disposed after the press section in the case of solid contents of 40 to 97% fibrous dry weight.

The prior art is represented by feed sites on the transfer screen/belt, e.g. ahead of mat transfer in a TAD layout, and the supply to the moist fibrous mat after its transfer to the transport (dry) felt before the press or presses in a conventional single-felt or double-felt tissue machine.

The supply of treatment chemicals by spray application onto the yankee cylinder is also known in the prior art.

The addition of the treatment agent within the tissue making machine is brought about by spray application onto the pope roller to produce a film of treatment agent and subsequently to transfer it to the tissue web during rolling up. The already creped “tissue web” usually still exhibits a residual temperature of between 20° C. and about 70° C. as a result of the preceding drying process on the yankee cylinder, which benefits the distribution of treatment agent and its penetration of the raw tissue.

In addition to spray application via a nozzle bar, the use of centrifugal rotors or brush units is possible. Application may also be effected directly onto the tissue paper web.

Addition of the treatment agent, within a so-called doubling machine or within the processing machine, to the outer plies of the multiply doubled web before or during calibration/smoothing is generally preferred.

Application of the treatment agent to the outer plies of the web frequently takes place within the processing machine, the web being guided in multiply fashion by use of a plurality of unwindings in the processing machine or being previously doubled in multiply fashion.

WO 98/41687 describes a method of making tissue products of the aforementioned kind, this method being characterized by the fact that a composition of the above type is applied to the fibrous mat or tissue web within the screen section, press section, TAD section, on the yankee cylinder and/or dry section, i.e. at a fibrous material density of 20 to 97%, relative to the web's dry fibrous weight, in an amount of 0.1 to 40%, preferably 1 to 20%, continuously or discontinuously on or within the web and the web may undergo post-smoothing after application.

An alternative embodiment mentioned in this document relates to a method of making tissue products, this method being characterized by the fact that a composition of the above type is applied to the fibrous mat or tissue web after the dry section on the wadding machine, doubling machine and/or in the automatic processor in an amount of 0.1 to 40 wt. %, preferably 1 to 20 wt. %, continuously or discontinuously on or within the web and the web may undergo post-smoothing after application.

The techniques described above teach either application methods in which the treatment chemicals are to penetrate the tissue as evenly as possible, or relate to the external application of treatment chemicals in a single layer that does not completely penetrate the tissue.

If the treatment compositions are blends of several components applied in a single layer, individual components sometimes cannot develop their action to an optimum degree. An example of this is represented by cosmetic lotions that protect the skin upon contact with the tissue, in combination with (poly)siloxanes that influence the tissue's surface softness.

Another disadvantage entailed by the application of blends is that the individual constituents of the treatment composition often exhibit very different physical properties so that the application may cause technical difficulties in a single application process.

### OBJECT OF THE INVENTION

It is therefore the present invention's object to make available a method that enables a controlled distribution of treatment compositions (e.g. lotions) in a fiber-based planar product, particularly tissue, the distribution being optimized for each particular use.

It is also the present invention's object to provide a planar product, particularly tissue, that is characterized by a correspondingly optimized combination of features.

### DESCRIPTION OF THE INVENTION

These objects are solved by a method of applying treatment chemicals to a dry fiber-based planar product, particularly dry, creped tissue, such a method comprising the steps of:

a) applying a first treatment composition containing at least a first treatment chemical to a planar product so as to produce a first layer having at least a first treatment chemical, and

b) applying at least a further treatment composition containing at least one other treatment chemical to produce another layer on the first layer, this further layer having at least one other treatment chemical.

One advantage of this dry web method, when compared to wet web methods, is the unrestricted use of chemicals, regardless of their heat sensitivity, since the chemicals added are not subjected to heating in the drying section of a tissue paper machine (after the wet-laying of a fibrous web). Further the method of the invention allows (more or less) saturating the tissue web with the first layer which can enhance the localization of the “further layer(s)” of treatment chemicals on the surface of the tissue material. This localization is more difficult to achieve with wet web methods. Moreover it is believed that some chemicals adhere better to dried cellulosic fibres than to wet ones.

The above steps (a) and/or (b) may optionally be followed by drying steps to remove any volatile constituents such as solvents.

Upon application of more than two layers, the “other” treatment chemicals differ from the treatment chemical of that layer to which they are applied. The application of two layers is preferred.

The term “layer” as used here in conjunction with the application of treatment compositions is not restricted to layers located on the outer surface of the fiber-based planar product, particularly tissue. The first (inner) layer in particular can thus completely penetrate the planar product, especially tissue. These layers may also partially, but not fully overlap.

The first layer and further layer(s) can be applied in succession using the same device, though in different conditions, particularly at different temperatures. For example, if the intention is to apply a solid (at room temperature, e.g. a wax) and a liquid, it is possible to work e.g. in succession using two pressure rolls of the same type, the roll that applies the solid being heated. Such a systematic application plays a major role particularly in the cosmetic lotions sector where many constituents exhibit softening temperatures above 25° C., but do not need any excessive heating (e.g. no more than 80° C.) to be converted into the liquid state.

Alternatively, the first layer and further layer(s) can be successively applied using different devices.

Depending on the properties of the treatment composition to be applied, the application device(s) are for example chosen from among a spray unit (e.g. via a nozzle bar), a cooling tower, a brush unit, a centrifugal rotor, a calender and/or an application roll (e.g. pressure rolls). A transfer technique can also be adopted, as described e.g. in WO 94/05857.

A suitable time for application of the first and/or other layers within the production of the planar product, e.g. tissue (paper) manufacturing, can be chosen in a manner known to specialists. The approaches described in the introductory section of the application in relation to the prior art are, for instance, also suitable here. In the case of a conventional single-felt or double-felt tissue machine, the treatment composition can be applied e.g. by feeding it to the moist fiber mat after its transfer to the transport (dry) felt. In the case of application as a pure substance, particularly when the treatment compositions exhibit a high viscosity, pressure rolls or calenders are particularly suitable.

The treatment composition may comprise a single treatment chemical or a blend of at least two treatment chemicals. This treatment composition may also contain compounds that have no influence or only a slight influence on the properties of the treated planar product, particularly tissue, e.g. solvents (such as water and/or alcohol), auxiliary substances and/or additives. It may therefore be present e.g. as an aqueous solution or dispersion (e.g. suspension or emulsion) or comprise one or more treatment chemicals (water not included). Water may, however, also be an important active constituent of the treatment composition, particularly in cosmetic lotions intended to achieve a pleasant moist sensation on the skin. Water is then preferably used in combination with hygroscopic compounds such as the polyhydroxy compounds described below. Depending on the treatment composition's function, the proportion of optionally present solvents (including water) in the composition is preferably less than 60 wt. %, with greater preference on less than 30 wt. %, even greater preference on less than 10 wt. %, particularly less than 5 wt. %, each relative to the total weight of the composition.

The treatment chemical(s) may be selected from the following compound classes or compounds.

Agents for skin care and protection, so-called cosmetic lotions such as

moisturizers, such as substituents for the skin's natural moisturizing factor (NMF) that contain e.g. cleavage products of collagen, glycerol etc.;

skin care agents, e.g. long-chain fatty acid esters (like sorbitan fatty acid ester or Cetiol®), lanolin or derivatives thereof;

fragrances, e.g. natural, naturally identical or artificial perfumes; and/or

active cosmetic ingredients like D-panthenol or the active camomile ingredient α-bisabolol or agents exhibiting other functions, e.g.

strength-enhancing agents, particularly wet-strength agents like epichlorohydrin resins or crosslinked polyalkylene amines,

agents that promote the softness (e.g. bulk softness or surface softness) of the planar product, particularly the tissue; e.g. a polyhydroxy compound (e.g. ethylene glycol, propylene glycol, a liquid polyethylene glycol (derivative), a liquid polypropylene glycol (derivative) and/or glycerol), also quaternary ammonium compounds as described e.g. in U.S. Pat. No. 5,312,522 or 5,397,435 and the prior art cited therein, optionally in combination with the polyhydroxy compounds described in both these documents; or a poly(siloxane), particularly the (poly)siloxanes described in EP-A-347 153 and EP-A-347 154,

surfactants used e.g. as absorption rate control agents, e.g. long-chain quaternary ammonium compounds that may also exhibit softness-promoting action,

waxes, oils, and/or

inorganic or organic pigments or dyes.

A preferred basic composition for improving softness, especially bulk softness, comprises the following recipe:

glycerol: 40-45%

propylene glycol: 28-30%

linden extract: 2.5-3.5%

water up to 100%

The total amount of nonvolatile treatment chemical(s) applied in the treated surface area of the planar product, particularly tissue, is preferably 0.01 to 50 wt. %, with greater preference on 0.5-45 wt. % and even greater preference on 0.75-40 wt. %, relative to the weight of the untreated oven-dried planar product, particularly tissue (oven-dried being understood in accordance with German standard DIN EN 20638). Even greater preference is given to values of 1-35 wt. %, particularly 2-30 wt. % (what is considered to be volatile is any component that volatilizes upon further processing of the planar product, especially tissue, e.g. solvent such as water, unless it is intended to remain in the composition, e.g. a cosmetic lotion.).

The first layer preferably comprises a (poly)siloxane and/or a surfactant. Surfactants may exhibit an action that accelerates absorption (as regards any liquids applied to the planar product) and/or promote the softness of the planar product, particularly tissue. (Poly)siloxanes, e.g. the compounds described in EP-A-347 153 and EP-A-347 154, promote the tactile properties, especially softness, of the planar product, particularly tissue.

The other layer (particularly the outer-most layer) preferably comprises one or more constituents of a cosmetic lotion. In this way, the cosmetic constituents can completely develop their effect during use (e.g. skin care, surface softness etc.) without any interference from the treatment chemical(s) of the first layer. The cosmetic lotion is preferably creamy.

In a preferred embodiment, the first layer contains a (poly)siloxane and/or a surfactant in a total amount of 1-3 wt. %, and the second layer contains one or more constituents of a cosmetic lotion in a total amount of 4-5 wt. %, each relative to the planar product (oven-dried).

In a further preferred embodiment

the first layer contains at least one treatment chemical imparting bulk softness to the fibrous planar material, in particular dry, creped tissue material, e.g. a polyhydroxy compound (for instance in the form of the above-explained basic composition) or a quaternary ammonium compound as described above, and

the second layer contains at least one other treatment chemical, preferably agents classified as cosmetic lotions and/or treatment chemicals imparting surface softness to the fibrous planar material, in particular dry, creped tissue material, e.g. poly(siloxanes) as mentioned.

The present invention also relates to a fiber-based planar product, in particular a dry, creped tissue material, that contains a treatment composition; this product can be obtained according to a method that comprises the steps described above. The term “fiber-based planar product”, as used here, stands for planar products made of fibers (especially fibers that contain cellulose, such as pulp), for example nonwovens or tissues, with tissue representing a particularly preferred embodiment.

The term “tissue” as defined by the present invention is understood as any kind of creped paper made from an aqueous dispersion and having a basis weight range of usually between 10 and 65 g/m². In accordance with the invention, the term “tissue” covers both

the entire range of raw creped paper, also known as “raw tissue”, particularly the range of dry-creped raw tissue paper, regardless of whether they are single-layer or multilayer,

and any single-layer or multilayer end products made of this creped raw paper.

“Raw tissue” is usually made as a one-ply tissue web in the tissue (paper) machine or as an optionally multiply (intermediate) product, e.g. in the form of multiply doubled webs or in the form of master rolls for further processing. The term “layers” refers to a change in chemical and/or physical properties within a tissue ply; such a change may be caused e.g. by a different fiber composition. In contrast to plies, layers usually cannot be separated from one another.

The final product is preferably

a cleaning wipe, e.g. wiping paper, a windscreen cleaning wipe, a cleaning wipefor industrial applications, a towel or a cleaning wipefor household use, e.g. kitchen paper;

a sanitary product, e.g. toilet paper (also moist);

a paper handkerchief (also moist);

a household towel, e.g. kitchen towels;

a towel;

a tissue for facial use, e.g. a makeup removal tissue (facial) or cosmetic tissue,

a serviette/napkin,

bed linen;

a garment, e.g. disposable apparel for hospitals or kitchen staff.

Particularly preferred tissue products are handkerchiefs, tissues for facial use, sanitary products (e.g. toilet paper) and towels in which the application of cosmetic treatment compositions and/or treatment compositions that convey softness (lotions) plays a part.

The term tissue paper must also be regarded independently of the fibrous raw material to be used, particularly irrespective of whether the fibrous raw material is made solely or mainly from natural pulps e.g. according to the sulfate or sulfite process, or is used in a mixture with chemothermomechanical wood pulps (e.g. CTMP, or HTCMP), or whether the fibrous raw material used comes from a secondary fiber refinement process and whether the fibrous raw material needed to make tissue therefore completely or partially comprises “recycled fibers”.

To distinguish from nonwovens, it should be noted that although the predominant use of natural (cellulose-containing), i.e. vegetable, pulp fibers broken up in a manner suitable for paper making is typical of tissue paper manufacturing, a proportional use by refinement of modified pulp fibers in a range of 10 to 50 wt. %, relative to the total weight of the fibers, or even a use of synthetic fibers suitable for paper making in an amount of 10 to 30% are covered by the aforementioned definition of the term “tissue”. It is analogously possible to apply the method beyond the field of paper making to corresponding fields in the nonwoven and textile sectors.

Upon application of the treatment composition, it is possible to start out e.g. from a multiply, usually two-ply to four-ply or multiply (doubled) master roll produced in a separate doubling machine. A plurality of one-ply tissue webs can alternatively be treated (one unwinding each) and then jointly rolled up into a multiply tissue product via a roll-up device. This produces the advantage that e.g. the inner plies can be treated with a treatment chemical other than that for the outer plies. For example, the inner plies of a four-ply end product can remain untreated, or can be treated with a strength-enhancing agent, whereas the two outer plies were treated with a treatment chemical to improve surface softness. In principle, an extremely wide variety of combinations of differently treated tissue plies is conceivable.

In one embodiment, the tissue is a four-ply or three-ply doubled raw tissue for making handkerchiefs or facials, the tissue being made available in the form of master rolls for the application of a treatment agent in a processing machine suitable for this purpose. The processing machine comprises at least one unwinding device for the master rolls, a roll-up device for the product finished after application of a treatment agent, and an interposed applicator for applying the treatment agent.

To explain the present invention, reference is also made to the introductory portion of the specification where general properties and production steps are described in more detail for tissue (products).

1. A method of applying treatment chemicals to a dry, creped tissue material, said method comprising the steps of:
a) applying a first treatment composition containing at least one treatment chemical to said dry, creped tissue material to produce a first layer having at least one first treatment chemical, and
b) applying at least one further treatment composition containing at least one other treatment chemical to produce at least one further layer on said first layer, said further layer having at least one other treatment chemical.

2. A method according to claim 1, wherein said first layer and further layer(s) are applied in succession using the same device, though under different conditions.

3. A method according to claim 2, wherein said layer(s) is (are) applied at different temperatures.

4. A method according to claim 1, wherein said first layer and further layer(s) are applied in succession using different devices.

5. A method according to claim 1, wherein two layers are applied.

6. A method according to claim 1, wherein said first and other layer(s) are applied by at least one application means selected from spray units, dripping or trickling installations, brush units, centrifugal rotors, calenders and application rolls.

7. A method according to claim 1, wherein said treatment compositions applied contain at least one constituent selected from moisturizers, skin care agents, fragrances, active cosmetic ingredients, strength-enhancing agents, agents that promote the softness of the tissue material, surfactants, waxes, oils, inorganic or organic pigments and dyes.

8. A method according to claim 1, wherein said treatment chemicals are applied in total amounts of 0.01 to 50 wt. %, relative to the tissue material (oven-dried).

9. A method according to claim 1, wherein said first layer contains at least one treatment chemical selected from (poly)siloxanes and surfactants.

10. A method according to claim 1, wherein said further layer contains one or more constituents of a cosmetic lotion.

11. A method of applying treatment chemicals to a dry, creped tissue material, said method comprising the steps of:
a) applying a first treatment composition containing at least one treatment chemical selected from (poly)siloxanes and surfactants to said dry, creped tissue material to produce a first layer, and
b) applying at least one further treatment composition containing at least one other treatment chemical selected from constituents of a cosmetic lotion to produce at least one further layer on said first layer.

12. A method according to claim 11, wherein said first layer contains a (poly)siloxane and/or a surfactant in a total amount of 1-3 wt. %, and said further layer contains one or more constituents of a cosmetic lotion in a total amount of 4-5 wt. %, each relative to the tissue material (oven-dried).

13. A tissue material obtainable by a method of applying treatment chemicals to a dry, creped tissue material, said method comprising the steps of:
a) applying a first treatment composition containing at least one treatment chemical to said dry, creped tissue material to produce a first layer having at least one first treatment chemical, and
b) applying at least one further treatment composition containing at least one other treatment chemical to produce at least one further layer on said first layer, said further layer having at least one other treatment chemical.

14. A tissue material according to claim 13 having two layers.

15. A tissue material according to claim 13, wherein said treatment compositions applied contain at least one constituent selected from moisturizers, skin care agents, fragrances, active cosmetic ingredients, strength-enhancing agents, agents that promote the softness of the tissue product, surfactants, waxes, oils, inorganic or organic pigments and dyes.

16. A tissue material according to claim 13, wherein the total amount of treatment chemicals is 0.01 to 50 wt. %, relative to the tissue material (oven-dried).

17. A tissue material according to claim 13, wherein the first layer contains at least one treatment chemical selected from (poly)siloxanes and surfactants.

18. A tissue material according to claim 13, wherein the further layer contains one or more constituents of a cosmetic lotion.

19. A tissue material obtainable by a method of applying treatment chemicals to a dry, creped tissue material, said method comprising the steps of:
a) applying a first treatment composition containing at least one treatment chemical selected from (poly)siloxanes and surfactants to said dry, creped tissue material to produce a first layer, and
b) applying at least one further treatment composition containing at least one other treatment chemical selected from constituents of a cosmetic lotion to produce at least one other layer on said first layer.

20. A tissue material according to claim 19, wherein said first layer contains a (poly)siloxane and/or a surfactant in a total amount of 1-3 wt. %, and said further layer contains one or more constituents of a cosmetic lotion in a total amount of 4-5 wt. %, each relative to the tissue material (oven-dried).
